(19) United States
(12) Patent Application Publication
(10) Pub. No.: US 2011/0183185 A1
(43) Pub. Date: Jul. 28, 2011

(54) HIGH POWER LITHIUM-ION BATTERY

(75) Inventor: Joseph Chuang, Taipei (TW)

(73) Assignee: LANYANG ENERGY TECHNOLOGY CO., LTD., Taipei City (TW)

(21) Appl. No.: 12/692,088

(22) Filed: Jan. 22, 2010

(51) Int. Cl. H01M 6/42

(52) U.S. Cl. 429/160

(57) ABSTRACT

A high power lithium-ion battery is disclosed. The high power lithium-ion battery includes a first housing, a first anode interface, a first cathode interface, and a plurality of lithium-ion battery units disposed in the housing. The first anode interface and the first cathode interface are disposed on a surface of the first housing. Each lithium-ion battery unit includes a second housing, a second anode interface, a second cathode interface, and a plurality of rolls disposed inside the second housing. The second anode interface and the second cathode interface are disposed on a surface of the second housing or inside the second housing. Each roll is configured by winding a stack constituted of an anode sheet, an isolation films, and a cathode sheets sequentially stacked one on another.

### BACKGROUND OF THE INVENTION

1. Field of the Invention

The present invention relates generally to a battery adapted for supplying electric power to an electronic apparatus, and more particularly, to a high power and high capacity lithium-ion battery.

2. The Prior Arts

In the current electronic and information era, the demand for mobile power supplies is rapidly increasing. Lithium-ion batteries, having the advantages of high voltage, high capacity, long cycle life, and outstanding security performance, have been widely employed in many fields such as portable electronic apparatuses, electric automobiles, space technology, and defense industry.

According to a conventional method of fabricating a lithium-ion battery, an anode sheet, an isolation film, and a cathode sheet are sequentially stacked one on another to form a stack, and then the stack is wound into a roll. In order to achieve the desired high capacity, the roll has to be configured with a plurality of loops, so that the roll usually has a large size. Accordingly, the overall size of the battery housing containing the roll must also be large. Therefore, the convenience of using or carrying such a battery is impacted. Further, the current flowing through such a roll is usually a large current, which may cause a high temperature and energy loss, or even an explosion of the battery.

### SUMMARY OF THE INVENTION

A primary objective of the present invention is to provide a high power lithium-ion battery as a solution of the difficulties of the conventional high capacity lithium-ion battery as discussed above, i.e., large size, great energy loss (low power), and unsatisfactory security performance.

The present invention provides a high power lithium-ion battery. The high power lithium-ion battery includes a first housing, a first anode interface, a first cathode interface, and a plurality of lithium-ion battery units disposed in the housing. The first anode interface and the first cathode interface are disposed on a surface of the first housing.

Each lithium-ion battery unit includes a second housing, a second anode interface, a second cathode interface, and a plurality of rolls disposed inside the second housing. The second anode interface and the second cathode interface are disposed on a surface of the second housing or inside the second housing. Each roll is configured by winding a stack constituted of an anode sheet, an isolation films, and a cathode sheets sequentially stacked one on another.

All of the lithium-ion battery units are connected in parallel, in which all second anode interfaces are welded together and then electrically coupled to the first anode interface, and all second cathode interfaces are welded together and then electrically coupled to the first cathode interface.

In such a way, a plurality of lithium-ion battery units, each having a lower capacity, are connected in parallel to obtain a lithium-ion battery having a higher capacity. In such a lithium-ion battery, the current is dispersed to flow by multiple rolls, so that the current flowing by each roll is relatively low. As such, the difficulties caused by the conventional lithium-ion battery, such as large size, great energy loss (low power), and unsatisfactory security performance, can be eliminated.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating a high power lithium-ion battery according to an embodiment of the present invention;

FIG. 2 is a schematic diagram illustrating a lithium-ion battery unit of the high power lithium-ion battery according to an embodiment of the present invention; and

FIG. 2A is a schematic diagram illustrating the stack of the anode sheet, the isolation film, and the cathode sheet according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

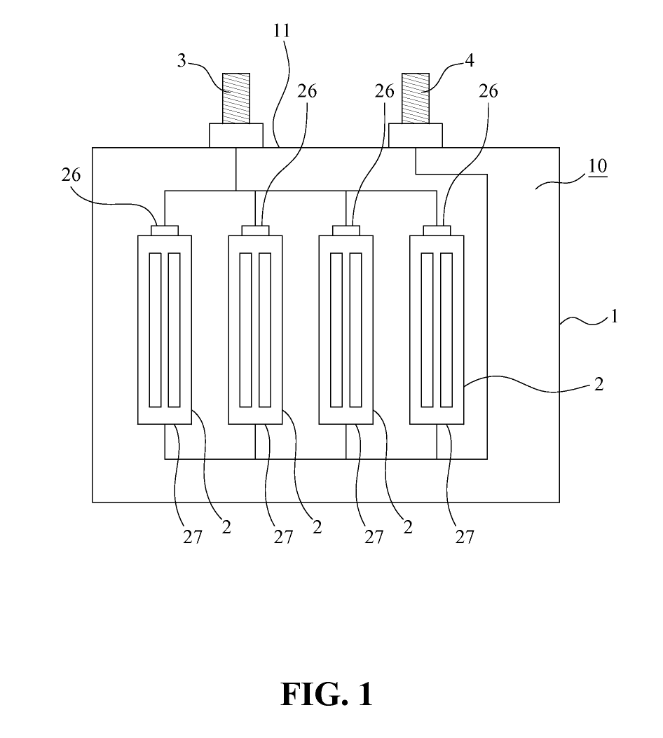

FIG. 1 is a schematic diagram illustrating a high power lithium-ion battery according to an embodiment of the present invention. Referring to FIG. 1, the high power lithium-ion battery includes a first housing 1, a plurality of lithium-ion battery units 2, a first anode interface 3, and a second cathode interface 4. The lithium-ion battery units 2 are disposed inside the first housing 1.

The first housing 1 is preferably made of a metal having an optimal conductivity, e.g., aluminum. Alternatively, the first housing 1 can also be made of a plastic material or a rubber material. The size of the first housing 1 is determined in accordance with the apparatus to be driven. The apparatus to be driven for example can be a power tool, an electric bicycle, an electric motor cycle, or the like. The first housing 1 is coated with an insulation layer. As shown in FIG. 1, an insulating cover plate 11 is disposed on a top side of the first housing 1, and the insulating cover plate 11 and the first housing 1 together define a first inner space 10. The first anode interface 3 and the first cathode interface 4 are secured on the cover plate 11. According to an aspect of the embodiment, the anode interface 3 and the cathode interface 4 are both configured in form of poles.

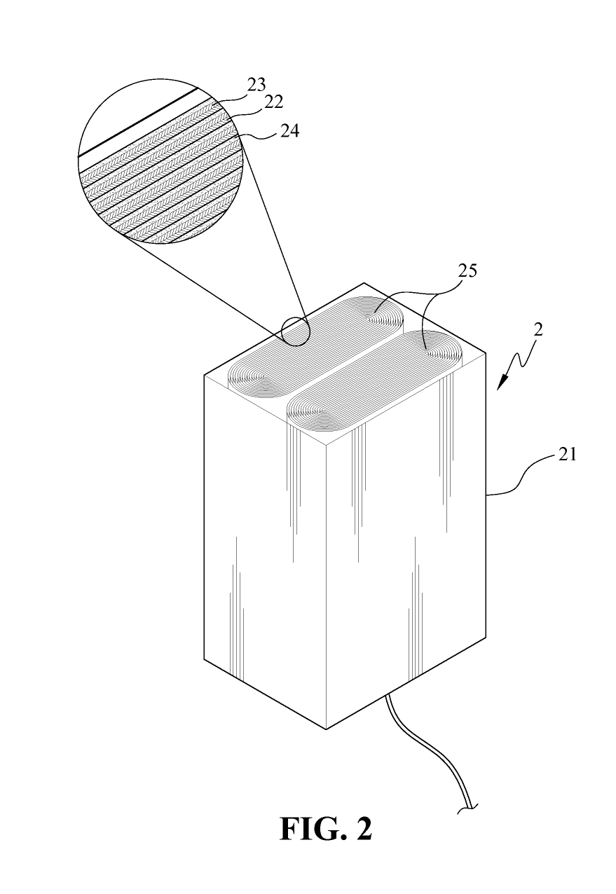

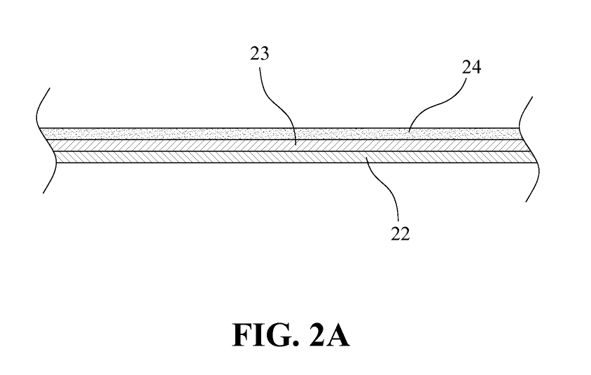

FIG. 2 is a schematic diagram illustrating a lithium-ion battery unit 2 of the high power lithium-ion battery according to an embodiment of the present invention. Referring to FIG. 2, the lithium-ion battery unit 2 includes a second housing 21, a second anode interface 26, a second cathode interface 27, and a plurality of rolls 25. The rolls 25 are disposed inside the second housing 21. The second housing 21 contains anode materials, and cathode materials. The anode materials include active agents, conductive agents, a solvent, an adhesive, and an anode sheet 22. Preferably, the anode sheet is an aluminum foil. The cathode materials include active agents, an adhesive, a solvent, and a cathode sheet 24. Preferably, the cathode sheet 24 is a copper foil. An isolation film 23 is provided between the anode sheet 22 and the cathode sheet 24. Preferably, the isolation film is a polypropylene film. As shown in FIG. 2A, according to an aspect of the embodiment, the anode sheet 22, the isolation film 23, and the cathode sheet 24 are sequentially stacked one on another to form a stack. According to an alternative aspect of the embodiment, a plurality of anode sheets 22, a plurality isolation film 23, and a plurality of cathode sheets 24 are sequentially and alternatively stacked one on another to form the stack. Then, the stack is wound into the roll 25. The quantity of the rolls 25 disposed in the second housing 21, and the size of each roll 25 can be determined in accordance with the practical application and are not to be restricted by the present invention.

Further referring to FIG. 1 together, the lithium-ion battery units 2 are arranged side by side and are electrically connected in parallel, in which all second anode interfaces 26 are coupled together and then electrically coupled to the first anode interface 3, and all second cathode interfaces 27 are coupled together and then electrically coupled to the first cathode interface 4. In such a way, although each roll 25 in a lithium-ion battery unit 2 has a relatively low capacity, the lithium-ion battery having all of the lithium-ion battery units 2 parallel connected together has a relatively high capacity and a high power.

In operation, the current flows through each roll 25 of each lithium-ion battery unit 2, and therefore a low current is outputted from any single lithium-ion battery unit 2. Because the lithium-ion battery units 2 are connected in parallel, the low currents outputted from the lithium-ion battery units 2 are added together to obtain a large current. Further, because the current flowing through each roll 25 is relatively low, the roll 25 is not likely to be caused with a high temperature. Furthermore, the stack of the anode sheets 22, the isolation films 23, and the cathode sheets 24 is adapted for a fast heat dissipation. As such, when such a lithium-ion battery is being charged, it won't be raised to a high temperature, so that the risk of explosion can be eliminated. Moreover, such a lithium-ion battery can be made in a small size while providing a strong power supply.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A high power lithium-ion battery, comprising:
a first housing, made of a metal or plastic material, and defining an inner space;
a first anode interface;
a first cathode interface, wherein the first anode interface and the first cathode interface are disposed on an surface of first housing; and
a plurality of lithium-ion battery units disposed inside the inner space, wherein each lithium-ion battery unit comprises:
a second housing;
a second anode interface;
a second cathode interface; and
at least one roll disposed inside the second housing,
wherein the second anode interfaces of the lithium-ion battery units are electrically connected together and then electrically coupled with the first anode interface, and the second cathode interfaces of the lithium-ion battery units are electrically connected together and then electrically coupled with the first cathode interface.

2. The high power lithium-ion battery as claimed in claim 1, wherein the roll comprises a plurality of base material layers alternatively and sequentially stacked one on another.

3. The high power lithium-ion battery as claimed in claim 2, wherein the base material layers comprise an anode sheet, an isolation film, and a cathode sheet.

4. The high power lithium-ion battery as claimed in claim 2, wherein the base material layers comprise a plurality of anode sheets, a plurality of isolation films, and a plurality of cathode sheets.
